(19) United States
(12) Patent Application Publication
(10) Pub. No.: US 2002/0101683 A1
(43) Pub. Date: Aug. 1, 2002

(54) Thin film coil and method of forming the same, thin film magnetic head, thin film inductor and thin film magnetic sensor

(76) Inventor: Toru Katakura, Miyagi (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/037,746

(22) Filed: Nov. 9, 2001

(30) Foreign Application Priority Data
Nov. 15, 2000 (JP) P2000-348429

(51) Int. Cl. G11B 5/17

(52) U.S. Cl. 360/123

(57) ABSTRACT

The present invention provides a thin film coil with low resistance and low inductance, and a method of forming the thin film coil, and a thin film magnetic head, a thin film inductor and a thin film magnetic sensor each using the thin film coil. In the thin film coil, at least the side surfaces of the conductor of a first coil are completely coated with an insulating film, and the conductor of a second coil is formed on a substrate with the insulating film provided therebetween. The thin film coil is formed by forming a plating underlying film on the substrate, forming the conductor of the first coil, etching off the plating underlying film except the portion below the conductor, forming the insulating film over the entire surface, forming a second plating underlying film on the insulating film, forming the conductor of the second coil by plating on the portion of the second plating film 16, which corresponds to the pitch interval of the first coil, and removing the second plating underlying film on the insulating film of the first coil.

### BACKGROUND OF THE INVENTION

1. Field of the Invention

The present invention relates to a thin film coil (thin film wiring) and a method of forming the same, and a thin film magnetic head, a thin film magnetic inductor and a thin film magnetic sensor each comprising the thin film coil.

2. Description of the Related Art

In a so-called helical magnetic tape system, for example, a video deck magnetic head in which recording and reproduction are performed on and from a magnetic tape such as a video tape or the like, a signal recorded on the tape is detected through a rotary transformer connected to the rear stage of a coil, and thus the resistance value of the coil is restricted, thereby causing the need to decrease the DC resistance to, for example, about 3Ω or less for improving frequency response.

Furthermore, in order to respond to the radio frequency band of 200 MHz or more, the inductance must be decreased to 100 nH or less.

When a thin film inductive head having the inductance of 100 nH or less is formed by a conventional method of forming a thin film magnetic head, the magnetic core length is 50 μm or less, the polar distance 20 μm or less, and the number of coil turns is 12 is less.

A conventional method of forming a coil is shown in FIGS. 19A to 20G.

First, as shown in FIG. 19A, a plating underlying film 102 having the same composition as a plating film, which constitutes a coil 103, on a substrate 101.

Next, as shown in FIG. 19B, a resist 110 is coated over the entire surface of the under film 102.

Then, the resist 110 is exposed and developed to form a predetermined pattern in the resist 110, as shown in FIG. 19C.

Then, as shown in FIG. 19D, a plating film is formed on the portions without the resist 110 by plating using the under film 102 as one of plating electrodes.

Then, as shown in FIG. 20E, the resist 110 is removed to leave the coil 103 comprising the plating film.

Then, in order to isolate the respective conductor turns of the coil 103 so that the coil 103 performs a predetermined operation, the under film 102 is removed from the spaces between the respective turns of the coil 103 by ion-etching 104 the under film 102 using, for example, argon ion (Ar⁺), as shown in FIG. 20F.

As a result, the thin film coil 103 shown in a perspective view of FIG. 20G is formed.

The interval of the coil 103 is conventionally designed in substantially proportion to the height of the coil 103. For example, when the height of the coil 103 is 3 μm, the interval of the conductor of the coil 103 must be set to about 2 μm.

Therefore, under the above-described conditions in which the magnetic core length is 50 μm or less, and the number of turns is 12 or less, the interval of the conductor or the coil 103 can be increased to only about 2 μm, and thus the coil height in the magnetic head is limited to about 3 μm

In this case, the DC resistance of the coil 103 is never 7Ω or less in any design.

Therefore, in order to decrease the resistance of the coil 103, it is necessary to further increase the thickness of the coil 103, and decrease the interval of the coil 103 to widen the coil 103.

For example, when the coil 103 has a height of 6 μm and an interval of 1 μm, the resistance of the coil can be decreased by sufficiently increasing the height/interval ratio of the coil 103 from the value (3/2) of the above case.

However, in this case, when the under film 102 is removed by etching after the plating film of the coil 103 is plated, the under film 102 cannot be completely removed to cause the problem of failing to accurately form the coil 103.

Namely, as shown in FIG. 21A, in ion etching 104, for example, with argon ions Ar⁺ for removing the under film 102 from the substrate 101, particles 104′ (Ar⁺) scattered from parallel beams of the argon ions are applied to the sides of the coil 103 comprising the plating film to emit the metal material of the coil 103, for example, Cu 105, as shown in FIG. 21B. Namely, the sides of the coil 103 are cut, and the emitted Cu 105 is again adhered (deposited) on the under film 102 at the bottom.

Furthermore, the coil 103 is thickened to make it difficult for the argon ion molecules to approach the under film 102. Therefore, the re-adhesion of copper to the under layer 102 is dominant over etching of the under film 102, thereby causing difficulties in removing the under film 102.

Therefore, as shown in FIG. 21c, the under film 102 cannot be completely removed from the spaces between the respective turns of the coil 103 to leave the under film 102 in these spaces, thereby failing to isolate the respective turns of the coil 103 to short-circuit the coil 103.

Therefore, a small thin film inductive head having a resistance value of as low as about 2Ω cannot be formed.

### SUMMARY OF THE INVENTION

In order to solve the above problem, an object of the present invention is to provide a thin film coil having low resistance and low inductance and a method of forming the same, and a thin film magnetic head, a thin film inductor and a thin film magnetic sensor each comprising the thin film coil.

A thin film coil of the present invention comprises at least a first coil and a second coil formed on a same substrate and each comprising a conductor thin film, wherein at least the side surfaces of the conductor of the first coil are completely covered with an insulating film, and the conductor of the second coil is formed on the substrate with the insulating film formed therebetween.

In the thin film coil of the present invention having the above construction, the entire side surfaces of the first coil are covered with the insulating film to insulate the conductor of the first coil from the conductor of the second coil, thereby permitting the formation of the first and second coils with narrow gaps therebetween.

A method of forming a thin film coil of the present invention comprises the step of forming a plating underlying film on a substrate, the step of depositing a conductor of a thin film coil in a predetermined pattern by plating on the plating underlying film, the step of etching off the plating underlying film except the portion below the conductor to form a first coil of the thin film coil, the step of forming an insulating film over the entire surface, the step of forming a second plating underlying film on the insulating film, the step of forming a conductor of a second coil of the thin film coil in a predetermined pattern by plating on the portion of the second plating underlying film, which corresponds to the pitch interval of the first coil, and the step of removing the second plating underlying film on the insulating film of the first coil.

In the method of forming a thin film coil of the present invention, the first coil is formed, and then the insulating film is formed over the entire surface of the first coil to insulate the conductor of the first coil. The conductor of the second coil is formed on the second plating underlying film formed on the insulating film to form a structure in which the conductors of the first and second coils are not connected to each other. Also, the second plating underlying film formed on the insulating film of the first coil is removed to cut off the second plating underlying film which continues in the spaces between the respective turns of the conductor of the second coil, thereby separating the respective turns of the conductor of the second coil.

Therefore, the thin film coil can be formed, in which the turns of the conductors of the first and second coil are separated from each other.

A thin film magnetic head of the present invention comprises a thin film coil comprising at least a first coil and a second coil formed on a same substrate, and two magnetic cores arranged with the thin film coil held therebetween and a magnetic gap held between the tip portions thereof, wherein at least the entire side surfaces of the conductor of the first coil are covered with an insulating film, and the conductor of the second coil is formed on the substrate with the insulating film provided therebetween.

In the thin film magnetic head of the present invention having the above construction, the magnetic cores are arranged with the thin film coil of the present invention provided therebetween, thereby narrowing the interval of the conductor of the thin film coil. Therefore, the resistance can be decreased by, for example, thickening the thin film coil, a magnetic field produced in the magnetic cores can be strengthened by, for example, increasing the number of turns of the thin film coil with the same area, and the area of the thin film coil can be decreased, for example, with the same number of turns.

A thin film inductor of the present invention comprises a thin film coil comprising at least a first coil and a second coil formed on a same substrate, wherein at least the entire side surfaces of the conductor of the first coil are covered with an insulating film, the conductor of the second coil is formed on the substrate with the insulating film formed therebetween, the first coil and the second coil of the thin film coil are electrically connected to each other, and one end of the thin film coil is connected to the outside, the other end being a free end.

In the thin film inductor of the present invention having the above construction, magnetic cores are arranged with the thin film coil of the present invention provided therebetween, thereby narrowing the interval of the conductor of the thin film coil. Therefore, the resistance can be decreased by, for example, thickening the thin film coil, and the number of turns of the thin film coil can be increased, for example, with the same area.

A thin film magnetic sensor of the present invention comprises a thin film coil comprising at least a first coil and a second coil formed on a same substrate, wherein at least the entire side surfaces of the conductor of the first coil are covered with an insulating film, and the conductor of the second coil is formed on the substrate with the insulating film formed therebetween.

In the thin film magnetic sensor of the present invention having the above construction, magnetic cores are arranged with the thin film coil of the present invention provided therebetween, thereby narrowing the interval of the conductor of the thin film coil. Therefore, the resistance can be decreased by, for example, thickening the thin film coil, and the number of turns of the thin film coil can be increased, for example, with the same area.

### BRIEF DESCRIPTION OF THE DRAWINGS

FIG. 1 is a schematic drawing (perspective view) of the construction of a thin film coil according to an embodiment of the present invention;

FIG. 2 is a sectional view taken along line II-II in FIG. 1;

FIGS. 3A to 3C are drawings showing the steps of a method of forming the thin film coil shown in FIG. 1;

FIGS. 4D to 4F are drawings showing the steps of the method of forming the thin film coil shown in FIG. 1;

FIGS. 5G to 5I are drawings showing the steps of the method of forming the thin film coil shown in FIG. 1;

FIG. 6 is a schematic drawing (perspective view) of the construction of a thin film magnetic head according to another embodiment of the present invention;

FIGS. 7A to 7C are drawings showing the steps of a method of forming the thin film magnetic head shown in FIG. 6;

FIGS. 8D to 8F are drawings showing the steps of the method of forming the thin film magnetic head shown in FIG. 6;

FIGS. 9G and 9H are drawings showing the steps of the method of forming the thin film magnetic head shown in FIG. 6;

FIG. 10 is a schematic drawing (perspective view) of the construction of a thin film magnetic head according to still another embodiment of the present invention;

FIGS. 11A to 11C are drawings showing the steps of a method of forming the thin film magnetic head shown in FIG. 10;

FIGS. 12D to 12F are drawings showing the steps of the method of forming the thin film magnetic head shown in FIG. 10;

FIGS. 13G and 13H are drawings showing the steps of the method of forming the thin film magnetic head shown in FIG. 10;

FIGS. 14I and 14J are drawings showing the steps of the method of forming the thin film magnetic head shown in FIG. 10;

FIG. 15 is a drawing showing the construction of a drum unit comprising a helical scanning magnetic head;

FIG. 16 is a drawing showing a thin film magnetic head according to a further embodiment of the present invention;

FIG. 17 is a drawing showing a thin film inductor according to a still further embodiment of the present invention;

FIG. 18 is a drawing showing a thin film magnetic sensor according to a further embodiment of the present invention;

FIGS. 19A to 19D are drawings showing the steps of a conventional method of forming a thin film magnetic head;

FIGS. 20E to 20G are drawings showing the steps of the conventional method of forming a thin film magnetic head; and

FIGS. 21A to 21C are drawings illustrating the problem of the conventional method of forming a thin film coil.

### DESCRIPTION OF THE PREFERRED EMBODIMENTS

The present invention provides a thin film coil comprising at least a first coil and a second coil formed on a same substrate and each comprising a conductor thin film. At least the side surfaces of the conductor of the first coil are completely coated with an insulating film, and the conductor of the second coil is formed on the substrate with the insulating film formed therebetween.

In the thin film coil of the present invention, the conductor of the first coil is formed on the substrate with a plating underlying film formed therebetween, and the conductor of the second coil is formed on the insulating film with a plating underlying film formed therebetween.

The present invention also provides a method of forming a thin film coil comprising the step of forming a plating underlying film on a substrate, the step of depositing a conductor of a thin film coil in a predetermined pattern by plating on the plating underlying film, the step of etching off the plating underlying film except the portion below the conductor to form a first coil of the thin film coil, the step of forming an insulating film over the entire surface, the step of forming a second plating underlying film on the insulating film, the step of forming a conductor of a second coil of the thin film coil in a predetermined pattern by plating on the portion of the second plating underlying film, which corresponds to the pitch interval of the first coil, and the step of removing the second plating underlying film on the insulating film of the first coil.

The present invention further provides a thin film magnetic head comprising a thin film coil comprising at least a first coil and a second coil formed on a same substrate, and two magnetic cores arranged with the thin film coil held therebetween and a magnetic gap held between the tip portions thereof, wherein at least the entire side surfaces of the conductor of the first coil are covered with an insulating film, and the conductor of the second coil is formed on the substrate with the insulating film formed therebetween.

The present invention further provides a thin film inductor comprising a thin film coil comprising at least a first coil and a second coil formed on a same substrate, wherein at least the entire side surfaces of the conductor of the first coil are covered with an insulating film, the conductor of the second coil is formed on the substrate with the insulating film formed therebetween, the first coil and the second coil of the thin film coil are electrically connected to each other, and one end of the thin film coil being connected to the outside, the other end being a free end.

The present invention further provides a thin film magnetic sensor comprising a thin film coil comprising at least a first coil and a second coil formed on a same substrate, wherein at least the entire side surfaces of the conductor of the first coil are covered with an insulating film, and the conductor of the second coil is formed on the substrate with the insulating film formed therebetween.

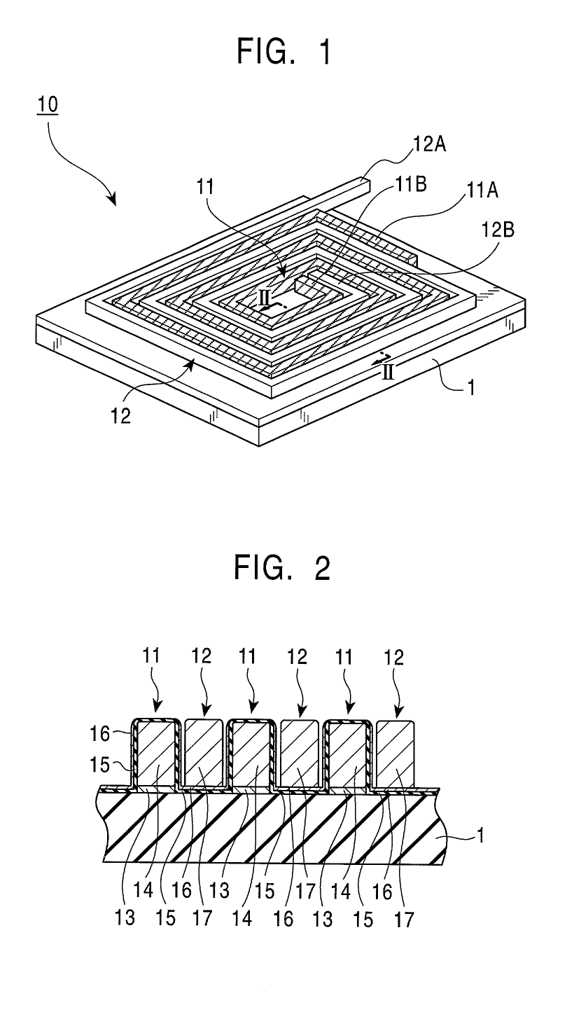

FIG. 1 is a drawing (perspective view) showing the construction of a thin film coil according to an embodiment of the present invention.

The thin film coil 10 shown in FIG. 1 comprises a first coil 11 (11A and 11B) and a second coil 12 (12A and 12B), which are spirally formed on a substrate 1. The first coil 11 is arranged inward of the second coil 12, and the two coils 11 and 12 are formed with a narrow gap therebetween. In FIG. 1, the first coil 11 is discriminated from the second coil 12 by shadowing.

The ends of the first and second coils 11 and 12, for example, the external end 11A of the first coil 11 and the internal end 12B of the second coil 12, are electrically connected through wiring or the like to form the thin film coil 10 comprising the first and second coils 11 and 12 formed with a narrow gap therebetween.

The wiring may be provided above or below the conductors of the coils 11 and 12 through an insulator except in a contact portion.

As the material for the thin film coil 10, a low-resistance metal material such as copper, gold, silver, platinum, aluminum, or an alloy containing these metals can be used.

Particularly, copper can easily be plated, and is thus suitable as the material for the thin film coil 10.

FIG. 2 is a sectional view taken along line II-II in FIG. 1.

The first coil 11 comprises a conductor coil 14 formed on the substrate 1 with an under film 13 provided therebetween, the upper and side surfaces of the conductor 14 being completely coated with an insulating film 15.

The second coil 12 comprises the insulating film 15 formed on the substrate to cover the conductor 14 of the first coil 11, an under film 16 formed on the insulating film 16, and a coil conductor 17 formed on the under film 16. The under film 16 is also formed on the insulating film 15 on the side surfaces of the first coil 11.

The under films 13 and 16 are left as electrodes for forming the conductors 14 and 17 of the coils by plating, and made of the same material as the conductors 14 and 17.

Although the material for the insulating film 15 is not limited, for example, alumina (Al₂O₃) can be used.

In the thin film coil 10 of this embodiment having the above construction, the conductor 14 of the first coil 11 is insulated from the conductor 17 of the second coil 12 by the insulating film 15 for each turn.

Also, the gap between the first coil 11 and the second coil 12 is very narrow, and thus the gap between the conductors 14 and 17 is also narrow in comparison to the width of the conductors 14 and 17. Therefore, only the insulating film 15, the under film 16 and the small gap are present between the conductors 14 and 17.

The method of forming the thin film coil 10 of this embodiment will be described below.

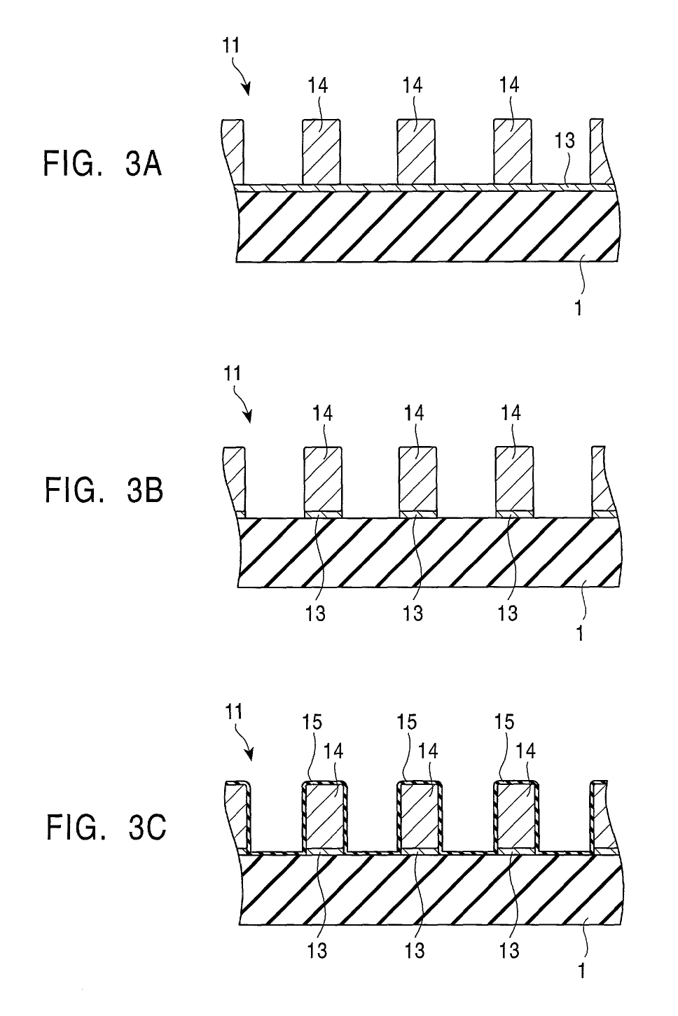

First, as shown in FIG. 3A, the conductor 14 of the first coil 1 is formed by plating on the substrate 1 with the under film 13 formed therebetween. The conductor 14 is formed at an interval corresponding to the portion in which the second coil 12 is later formed.

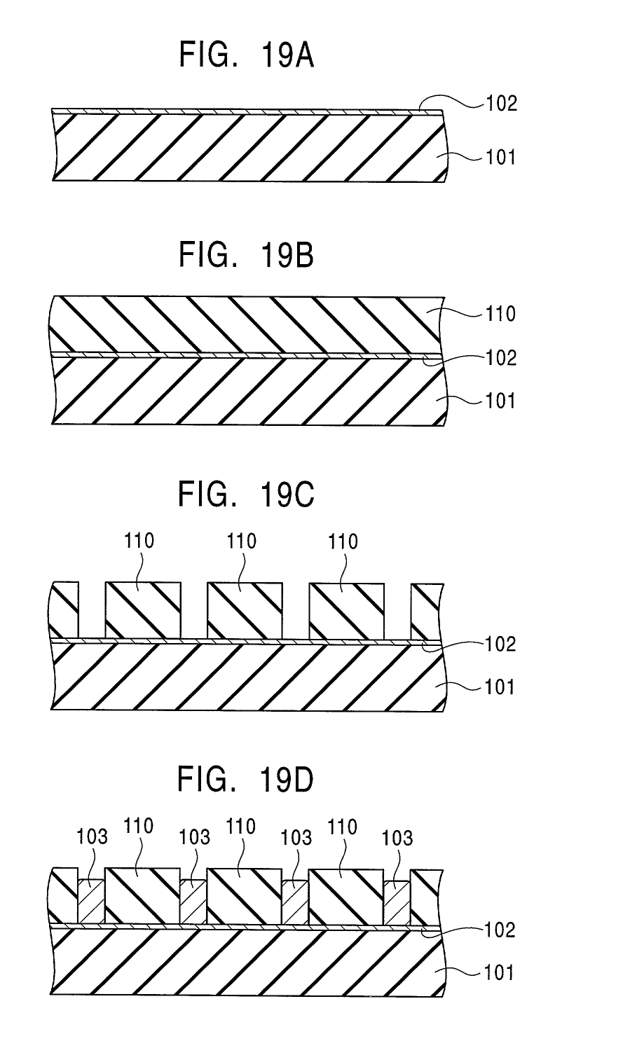

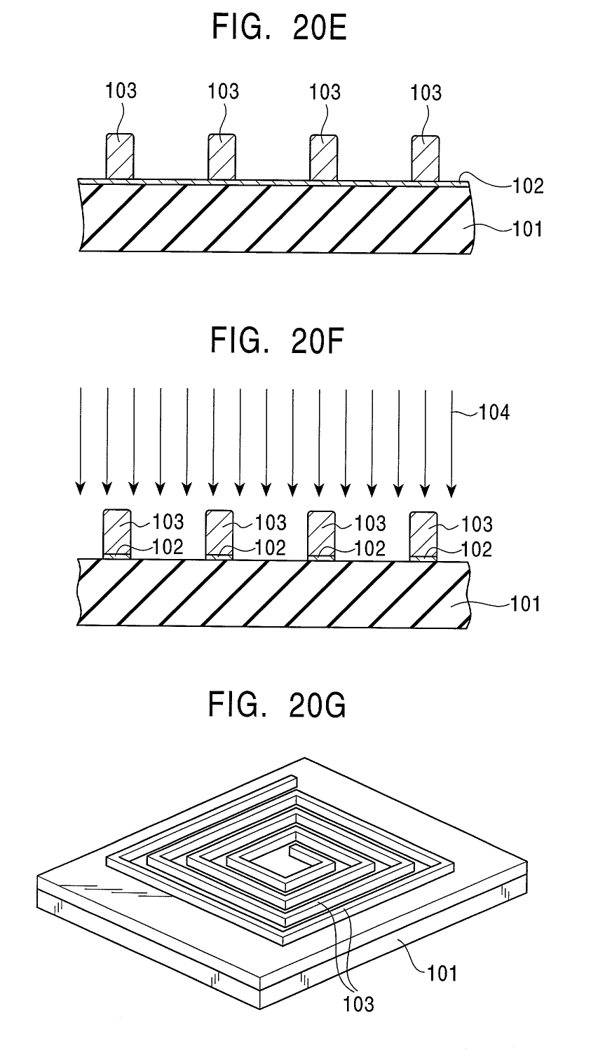

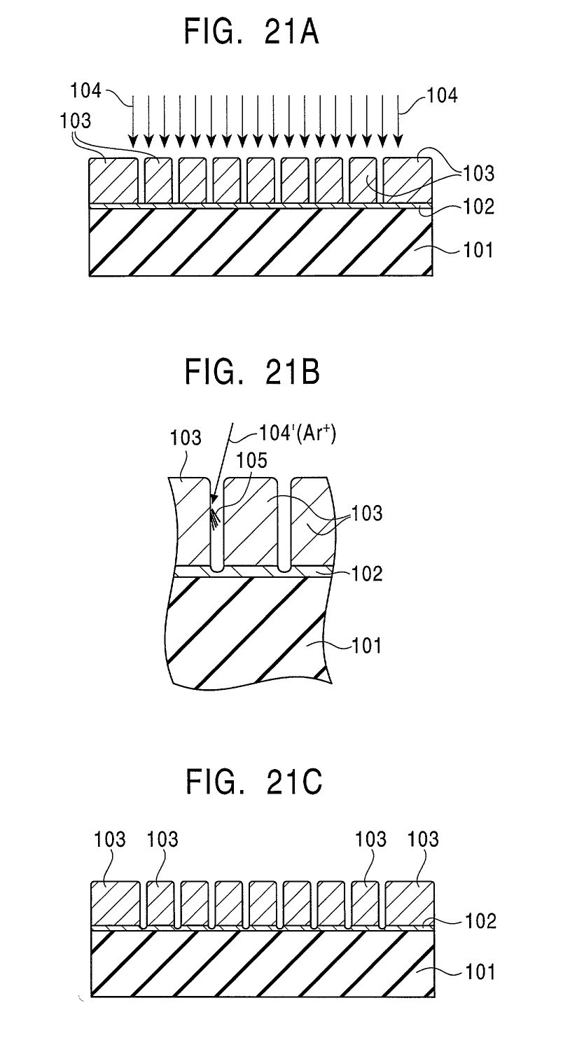

The state shown in FIG. 3A is obtained according to the steps of the conventional forming method shown in FIGS. 19A to 20E.

Next, as shown in FIG. 3B, the under film 13 is etched off except the portions below the conductor 14. Etching can be performed by ion etching, for example, with above-described argon ions (Ar⁺).

Next, as shown in FIG. 3C, the insulating film 15 made of, for example, alumina is formed over the entire surface of the conductor 14. In this step, in the portions where the second coil 12 is later formed, the surface of the substrate 1 is coated with the insulating film 15.

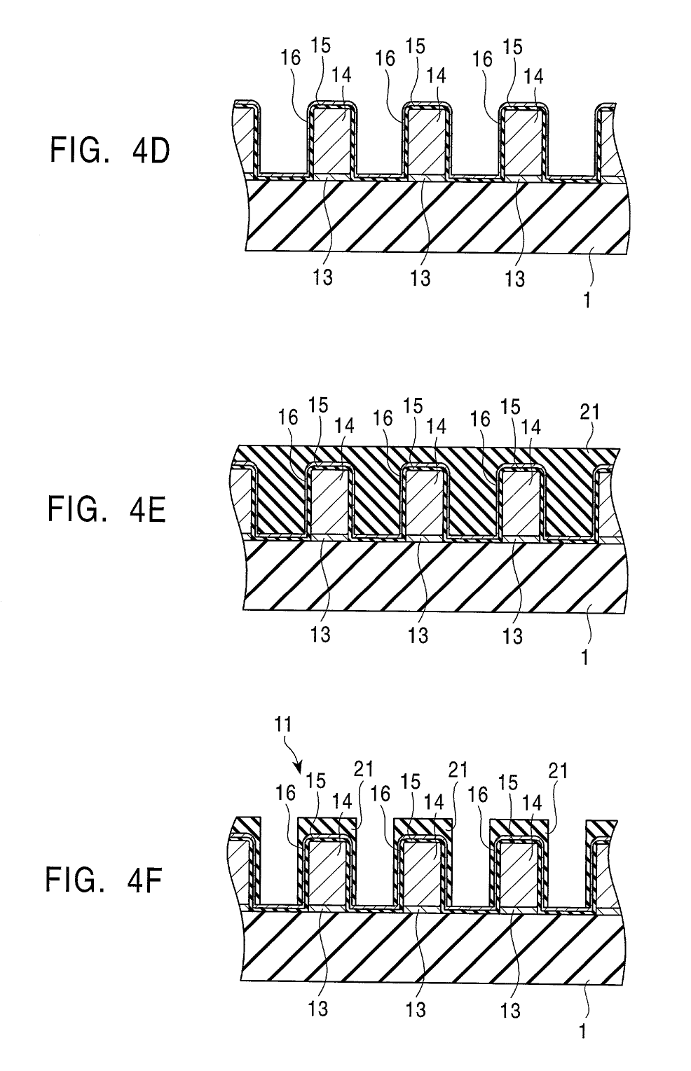

Then, as shown in FIG. 4D, the plating underlying film 16 is deposited over the entire surface of the insulating film 15.

Next, as shown in FIG. 4E, a resist 21 is coated over the entire surface of the under film 16.

Then, the resist 21 is patterned in a predetermined pattern by exposure and development, as shown in FIG. 4F. In this step, the resist 21 is thinly left on the side surfaces of the first coil 11.

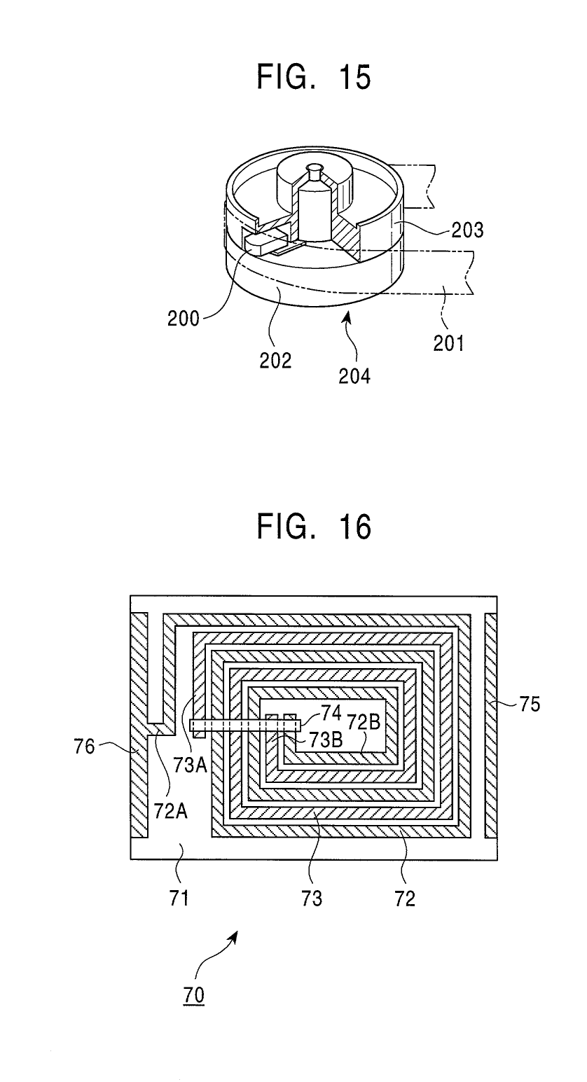

Next, as shown in FIG. 15G, the coil conductor 17 of the second coil 12 is formed in the recesses of the resist 21 by plating using the under film 16 as an electrode.

Then, as shown in FIG. 15H, the resist 21 is removed. In this step, narrow gaps are formed between the side surfaces of the first coil and the conductor 17 of the second coil 12.

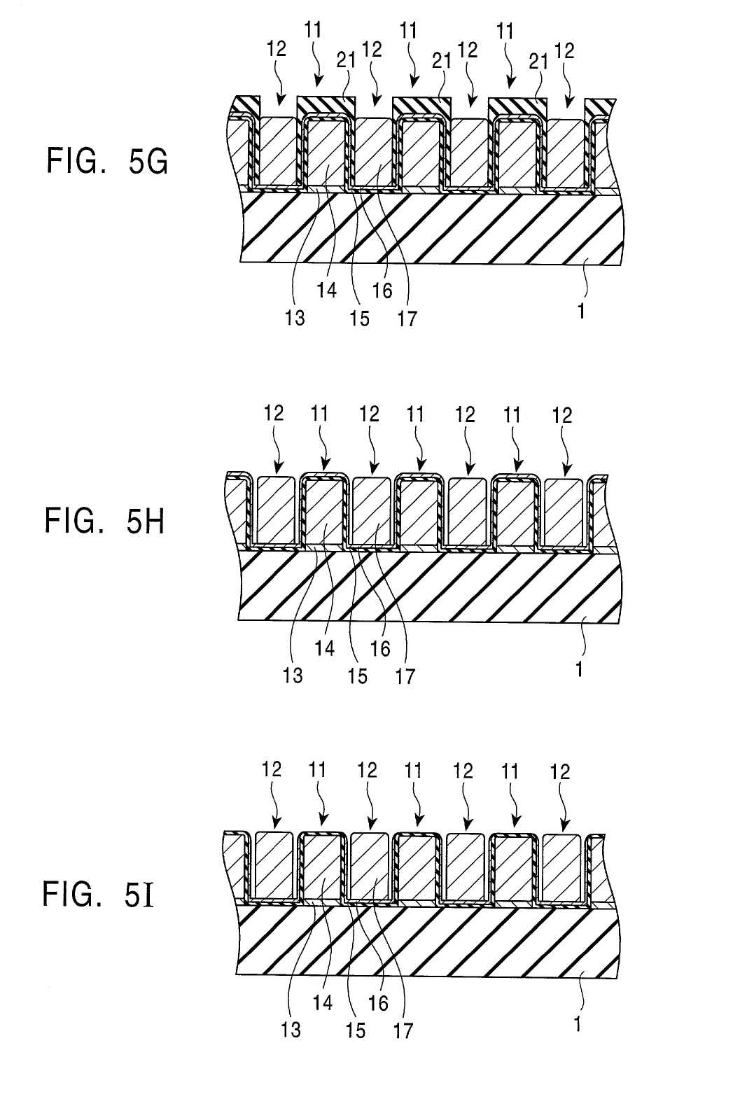

Furthermore, as shown in FIG. 5I, the under film 16 on the surface of the fist coil 11 is removed by etching, for example, the above-described ion etching. As a result, the turns of the conductor 17 of the second coil 12 are isolated from each other.

Then, an insulating film for covering the entirety, and wiring are formed to complete the thin film coil.

In this way, the thin film coil 10 shown in FIGS. 1 and 2 can be formed.

The construction of the thin film coil 10 of this embodiment can be applied to a case in which a coil conductor is formed by a method other than plating. In this case, the under films 13 and 16 shown in FIG. 2 are not formed, and thus the conductors 14 and 17 are formed on the substrate 1 and the insulating film 15, respectively. In this case, the conductor 14 can be insulated from the conductor 17 through the insulating film 15.

However, particularly when the thickness of the coil is increased as compared with the width, i.e., when the aspect ratio of the coil is increased, the aspect ratio of the recesses in which the coil conductor is formed is increased. Therefore, formation of the conductor by plating has the advantage that a good film can easily be formed.

Although, in this embodiment, the entire upper surface of the conductor 14 of the first coil 11 is coated with the insulating film 15, the entire upper surface of the conductor 14 needs not necessarily to be coated with the insulating film.

Even when at least the side surfaces of the conductor 14 are coated with the insulating film 15 to leave a portion of the upper surface conductor 14 uncoated with the insulating film 15, the thin film can be operated as a thin film coil as long as insulation of the conductor 14 from the under film 16 for the second coil 12 is secured.

In the thin film coil 10 of this embodiment, the upper and side surfaces of the conductor 14 of the first coil 11 are coated with the insulating film 15, and the conductor 17 of the second coil 12 is formed on the substrate 1 through the same insulating film 15 as the first coil 11, thereby securely insulating the conductors 14 and 17 of the coil 10 by the insulating film 15.

Therefore, even when the two coils 11 and 12 are formed with a narrow gap therebetween, each of the conductors 14 and 17 is insulated to cause no leakage, thereby permitting a reduction in the coil pitch as compared with a conventional coil. For example, the coil pitch can be decreased to 1.5 μm or less.

Also, even when the coil is thickened, each of the conductors 14 and 17 is insulated. Therefore, the coil can be thickened to, for example, a thickness of 4 μm or more, as compared with a conventional coil.

Therefore, the aspect ratio (coil height/coil width) of the coil can easily be increased to, for example, 3 or more, and the thickness of the coil can be increased to decrease the resistance and inductance of the coil.

Furthermore, the conductors are securely insulated from each other by the insulating film 15, thereby improving the yield of formation of the coil.

Like the thin film coil 10 of this embodiment, the thin film coil of the present invention can be applied to various devices each comprising the thin film coil.

Applications of the present invention will be described with reference to embodiments.

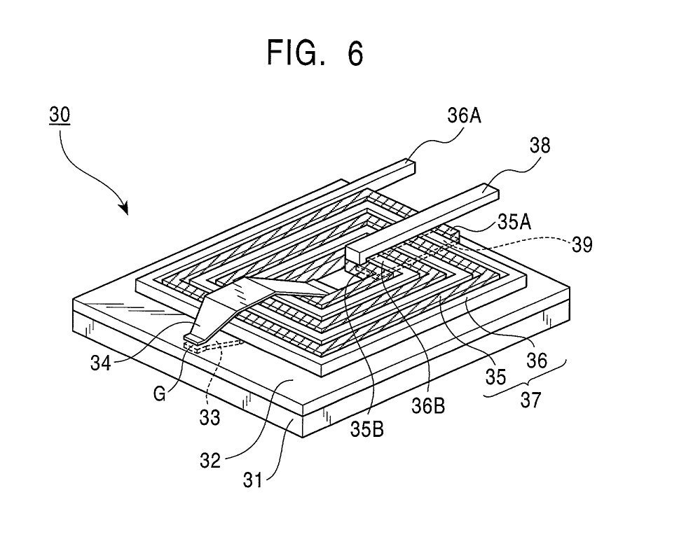

FIG. 6 is a schematic drawing (perspective view) showing an inductive thin film magnetic head in accordance with another embodiment of the present invention.

The thin film magnetic head 30 shown in FIG. 6 comprises a magnetic gap (recording gap) G formed between the tip portions of a lower magnetic core layer 33 and an upper magnetic core layer 34, and a thin film coil 37 provided in an intermediate portion between the lower and upper magnetic core layers 33 and 34.

The thin film coil 37 comprises first and second oil 35 and 36 having the same construction as the thin film coil 10 shown in FIGS. 1 and 2. In FIG. 6, wiring 38 is connected to the internal end 35B of the first coil 35, and connection wiring 39 is connected to the external end 35A of the first coil 35 and the internal end 36B of the second coil 26, as shown by broken line. This connection permits a current to flow through the first and second coils 35 and 36 in the same direction, thereby intensifying the magnetic fluxes produced by the current by each other.

This construction is formed on a substrate 31, and an insulating film 32 also used as a magnetic gap film is formed between the thin film coil 37 and the substrate 31.

The thin film magnetic head 30 can be formed, for example, as described below.

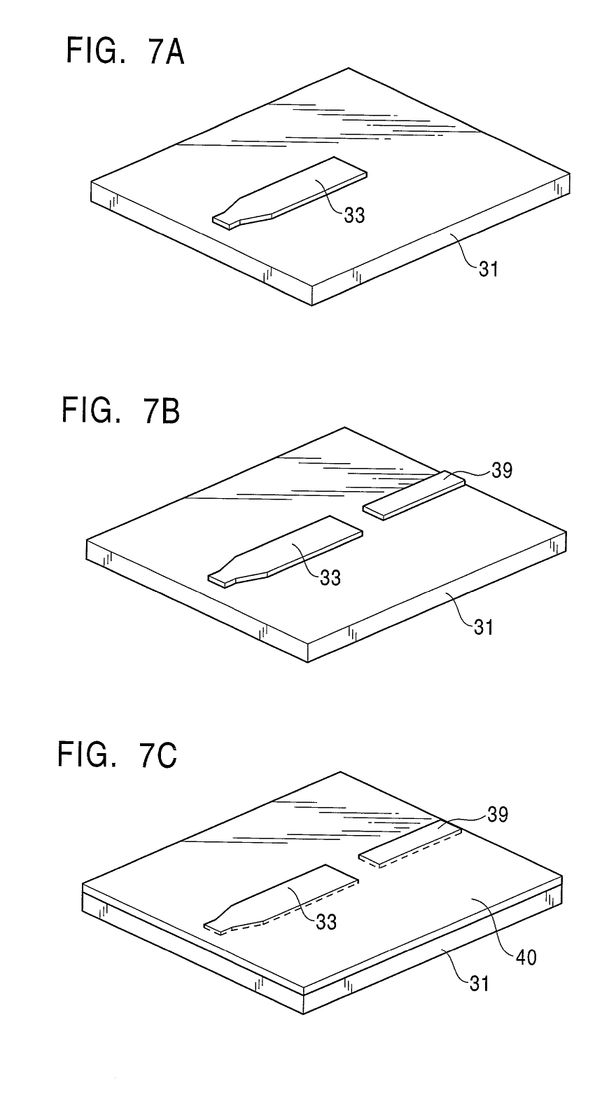

First, as shown in FIG. 7A, for example, permalloy (Ni—Fe alloy) is plated on the substrate 31 comprising, for example, an altic substrate to form the lower magnetic core layer 33 having a thickness of, for example, 3 μm.

Then, as shown in FIG. 7B, the connection wiring 39 is formed behind the lower magnetic core layer 33, for connecting the two coils 35 and 36 of the thin film coil 37.

Next, an alumina film 40 is deposited to a thickness of, for example, 5 μm over the entire surface by sputtering, and then the lower magnetic core layer 33 and the periphery thereof are planarized by mechanical polishing, as shown in FIG. 7C. This processing is performed for simplifying the subsequent steps. Namely, the lower magnetic core layer 33 and the connection wiring 39 are exposed from the surface of the alumina film 40 by planarization.

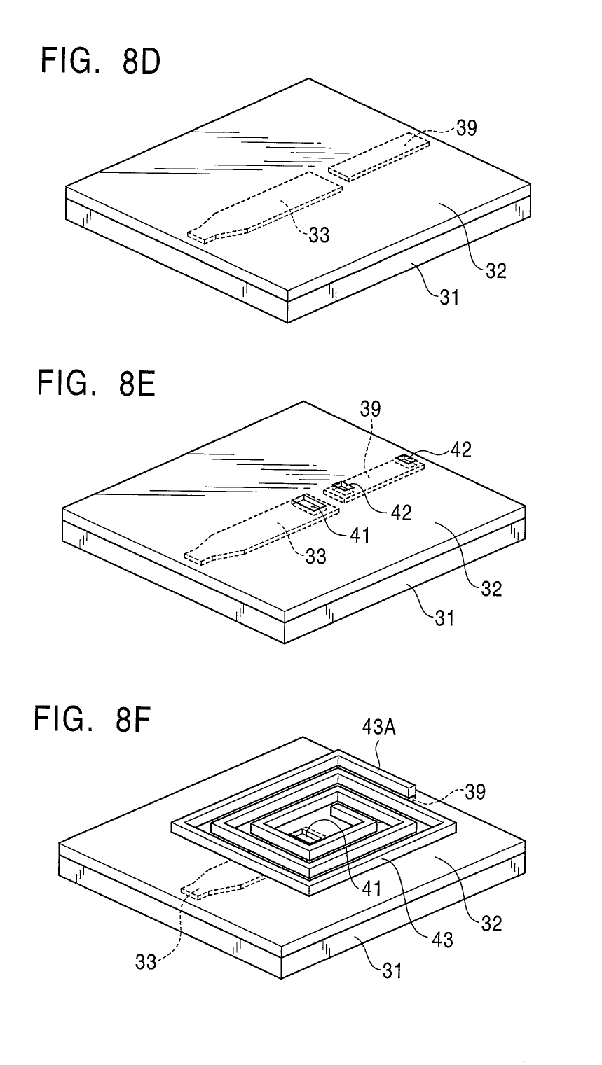

Next, for example, an alumina film is deposited as a gap film to a thickness of 0.5 μm over the entire surface. As a result, as shown in FIG. 8D, the lower magnetic core layer 33 and the connection wiring 39 are coated with the alumina film. FIG. 8D shows an insulating film 32 comprising an alumina film including the previously-formed alumina film 40 and the gap film.

Then, as shown in FIG. 8E, the gap film (the insulating film 32) is removed from the portion above the rear end of the lower magnetic core layer 33 and the portions above both ends of the connecting wiring 39, for forming a back gap hole 41 for connecting upper and lower poles, and connecting holes 42 for contact with the connection wiring 39.

The gap film may be removed by physical etching such as ion etching, or dissolution in an alkali solution.

Next, as shown in FIG. 8F, the conductor 43 of the first coil 35 of the thin film coil 37 is formed on the insulating film 32. First, a plating underlying film is deposited on the insulating film 32, and then a resist (not shown in the drawing) is patterned in the shape of the thin film coil according to the above-described method of forming a thin film coil.

In this step, the resist is patterned so that among the conductors of the final thin film coil 37, the conductor of the first coil 35 is formed alternately in order to facilitate etching of the under film.

In this way, the conductor 43 of the first coil 35 comprising a plated film is formed. The conductor 43 is formed so that one end 43A fills the rear end-side connection hole 42 of the connection wiring 39, thereby achieving electrical connection between the conductor 43 of the first coil 35 and the connection wiring 39.

Next, the resist is separated with a solvent, for example, acetone, and then the under film is removed by an ion etching apparatus except the portions below the conductor 43.

Then, an insulating film (corresponding to the insulating film 15 shown in FIG. 2) comprising, for example, an alumina film, is deposited to a thickness of, for example, 0.2 μm to cover the conductor 43, forming the first coil 35 of the thin film coil 37.

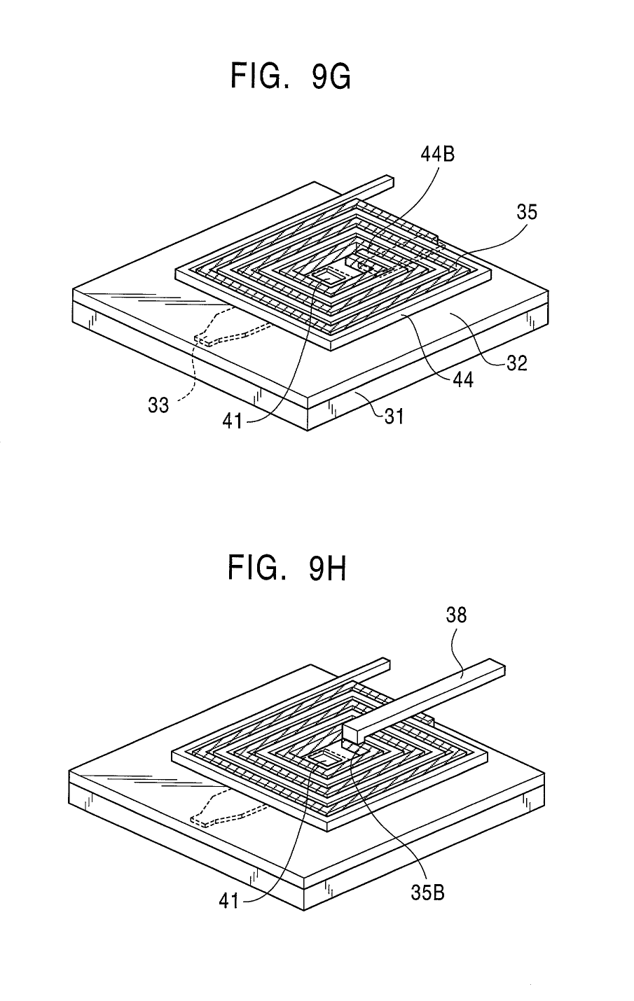

Then, as shown in FIG. 9G, the conductor 44 of the second coil 36 of the thin film coil 37 is formed by the same method as described above.

First, the insulating film filling the front end-side connection hole 42 of the connection wiring 39 is etched off.

Next, an under film is deposited on the insulating film coated on the conductor 43 of the first coil 35, and a resist pattern is formed on the under film to form recesses between the respective turns of the first coil 35.

Then, the conductor 44 of the second coil 36 is formed by plating. The conductor 44 of the second coil 36 is formed so that the internal end 44B fills in the front end-side connection hole 42 of the connection wiring 39. As a result, electrical connection between the conductor 44 of the second coil 36 and the connection wiring 39 can be attained.

Then, the surface is polished to remove the plating underlying film formed on the upper surface of the first coil 35, separating the respective turns of the conductor 44 of the second coil 36.

Then, an interlayer insulating film is formed to cover the thin film coil 37 comprising the first and second coils 35 and 36. In this step of forming the interlayer insulating film, the back gap hole 41 is masked to be avoided from being filled with the interlayer insulating film, or the interlayer insulating film formed on the back gap hole 41 is removed.

Next, as shown in FIG. 9H, the wiring 38 is connected to the internal end 35B of the first coil 35 through the connection hole formed in the interlayer insulating film.

Furthermore, the upper magnetic core layer 34 is formed above the lower magnetic core layer 33 so as to fill in the back gap hole 41. Therefore, the upper magnetic core layer 34 is connected to the lower magnetic core layer 33 through the back gap hole 41 to form a magnetic path.

In this way, the inductive thin film magnetic head 30 shown in FIG. 60 can be produced.

Since the thin film magnetic head 30 of this embodiment comprises the thin film coil 37 having the same construction as the above-described thin film coil 10, the distance between the conductors 43 and 44 of the thin film coil 37 can be decreased, and the resistance and inductance can be decreased by increasing the thickness of the thin film coil 37.

Therefore, the thin film coil 37 can be formed with a high density, and the number of turns of the thin film coils 37 can be increased with the same area. Therefore, the magnetic flux density can be increased to improve the efficiency of electromagnetic transformation.

Also, since the thickness of the thin film coil 37 can be increased, the horizontal sectional area of the thin film coil 37, which is necessary for passing the same current, can be decreased, and the interval of the thin film coil 37 can also be decreased.

Therefore, the area of the thin film coil 37 can be decreased to permit reduction in size of the magnetic cores 33 and 34, and miniaturization of the whole size of the magnetic head 30.

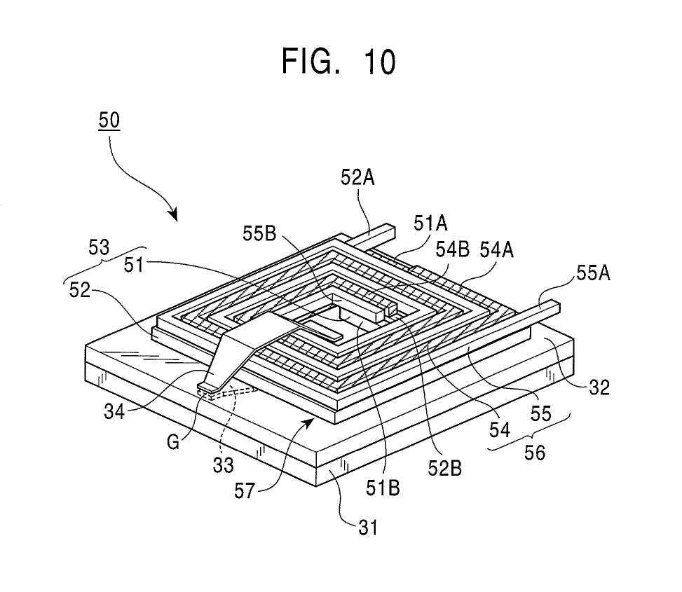

FIG. 10 is a schematic drawing (perspective view) of the construction of an inductive thin film magnetic head in accordance with still another embodiment of the present invention.

In this embodiment, particularly a thin film soil has a two-layer structure in which each of the coil layers comprises two coils. Namely, the thin film coil comprises four coils.

The thin film magnetic head 50 shown in FIG. 10 comprises a two-layer structure thin film coil 57 comprising a lower coil layer 53 comprising first and second coils 51 and 52, and an upper coil layer 56 comprising first and second coil 54 and 55.

The lower coil layer 53 and the upper coil layer 56 are arranged vertically opposite to each other with an interlayer insulating film (not shown in the drawing) provided therebetween.

Through connecting holes formed in the interlayer insulating film, the external end 54A of the first coil 54 of the upper coil layer 56 is connected to the external end 51A of the first coil 51 of the lower coil layer 53, the internal end 54B of the first coil 54 of the upper coil layer 56 is connected to the internal end 52B of the second coil 52 of the lower coil layer 53, and the internal end 55B of the second coil 55 of the upper coil layer 56 is connected to the internal end 51B of the first coil 51 of the lower coil layer 53. The remaining external end 52A of the second coil 52 of the lower coil layer 53 and the remaining external end 55A of the second coil 55 of the upper coil layer 56 are extended to be connected to the outside.

As a result, the four coils 51, 52, 54 and 55 are electrically connected through a path of the ends, 52A-52B-54B-54A-51A-51B-55B-55A. This electrical connection permits a current to flow through the four coils 51, 52, 54 and 55 in the same direction, thereby strengthening the magnetic flux produced by the current.

Of the other components, the same components as the thin film magnetic head 30 shown in FIG. 6 are denoted by the same reference numerals.

However, in this embodiment, the coils of the thin film coil 57 are connected directly, and thus no connection wiring is not formed for connecting the coils.

The thin film magnetic head 50 can be formed, for example, as described below.

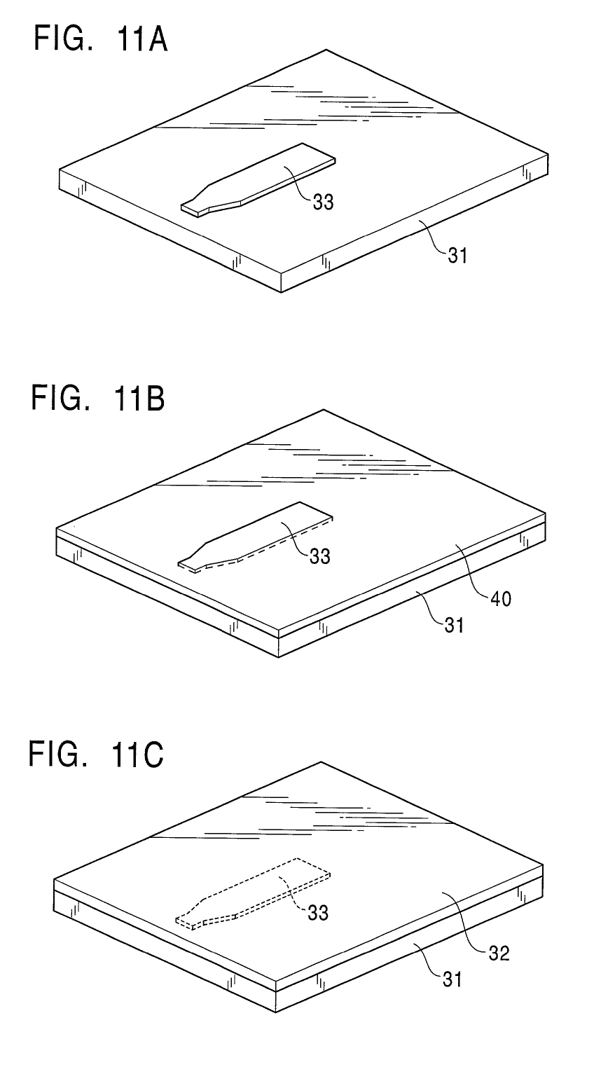

First, as shown in FIG. 11A, for example, permalloy (Ni—Fe alloy) is plated on the substrate 31 comprising, for example, an altic substrate to form the lower magnetic core layer 33 having a thickness of, for example, 3 μm.

Next, an alumina film 40 is deposited to a thickness of, for example, 5 μm over the entire surface by sputtering, and then the lower magnetic core layer 33 and the periphery thereof are planarized by mechanical polishing, as shown in FIG. 11B. This processing is performed for simplifying the subsequent steps. By the planarization process, the lower magnetic core layer 33 is exposed from the surface of the alumina film 40.

Next, for example, an alumina film for a gap film is deposited to a thickness of 0.5 μm over the entire surface to cover the lower magnetic core layer 33 with the alumina film, as shown in FIG. 11C. FIG. 11C shows an insulating film comprising the alumina films including the previously-formed alumina film 40 and the gap film.

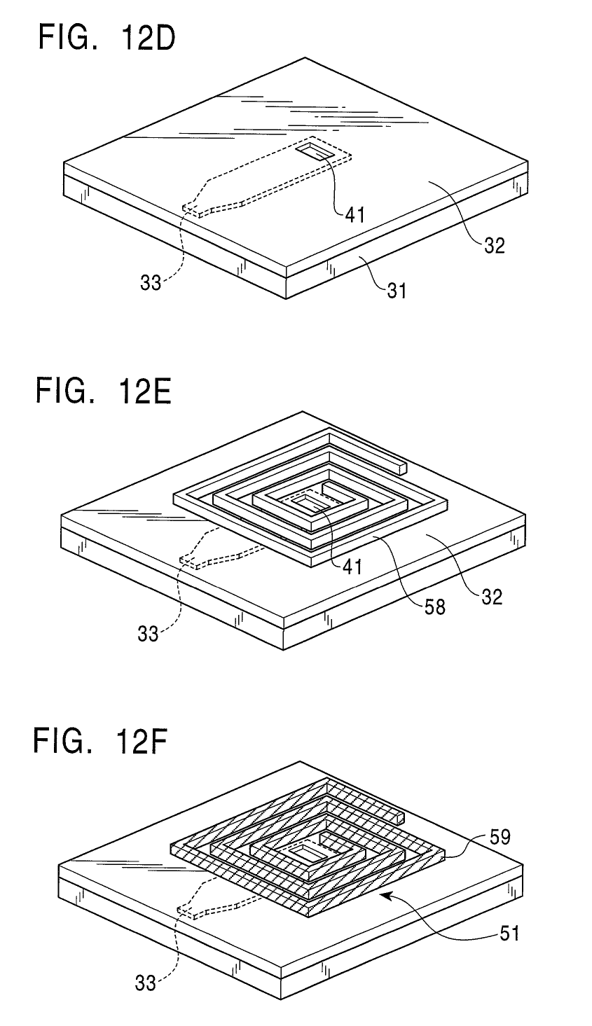

Then, in order to form a back gap hole 41 for connecting upper and lower poles, the gap film (the insulating film 32) is partially removed from the portion above the rear end of the lower magnetic core layer 33, as shown in FIG. 12D.

The gap film may be removed by physical etching such as ion etching or dissolution in an alkali solution.

Next, as shown in FIG. 12E, the conductor 58 of the first coil 51 of the lower coil layer 53 is formed on the insulating film 32.

Then, as shown in FIG. 12F, an insulating film 59 comprising, for example, an alumina film is deposited to a thickness of, for example, 0.2 μm to cover the conductor 58, to form the first coil 51 of the lower coil layer 53.

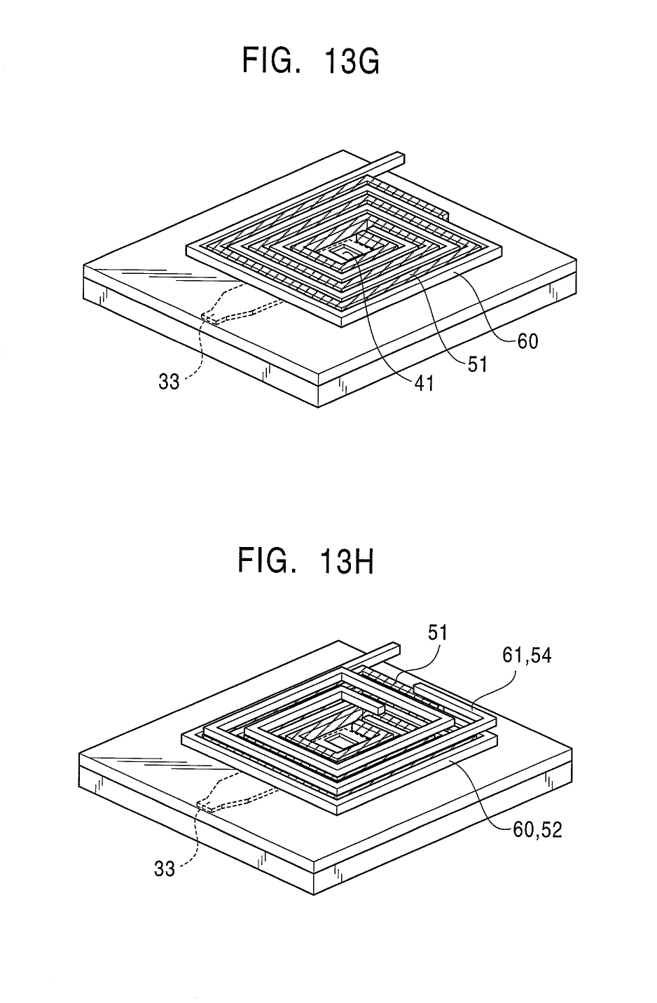

Then, as shown in FIG. 13G, the conductor 60 of the second coil 52 of the lower coil layer 53 is formed by the same method as described above.

In this step, an under film is deposited on the insulating film 59 formed to cover the conductor 58 of the first coil 51, and a resist pattern is formed on the under film to form recesses between the respective turns of the first coil 51.

Then, the conductor 60 of the second coil 52 is formed by plating.

Next, the surface is polished to remove the plating underlying film deposited on the upper surface of the first coil 51, separating the respective turns of the conductor 60 of the second coil 52.

Then, an interlayer insulating film (or a planarizing film) is formed to cover the lower coil layer 53 comprising the first and second coils 51 and 52. In this step of forming the interlayer insulating film, the back gap hole 41 is masked to be avoided from being filled with the interlayer insulating film, or the interlayer insulating film formed on the back gap hole 41 is removed.

Then, a connection hole (not shown in the drawing) is formed in the insulating film formed on the conductor at the end of each of the coils 51 and 52 of the lower coil layer 53, i.e., in the insulating film and/or the interlayer insulating film (or the planarizing film) formed to cover the conductor 58 of the first coil 51.

Next, as shown in FIG. 13H, the conductor 61 of the first coil 54 of the upper coil layer 56 is formed. In this step, the conductor 61 is formed so that both ends fill in the connection holes to be electrically connected to the conductor 58 of the first coil 51 of the lower coil layer 53 or the conductor 60 of the second coil 52 thereof through the connection holes.

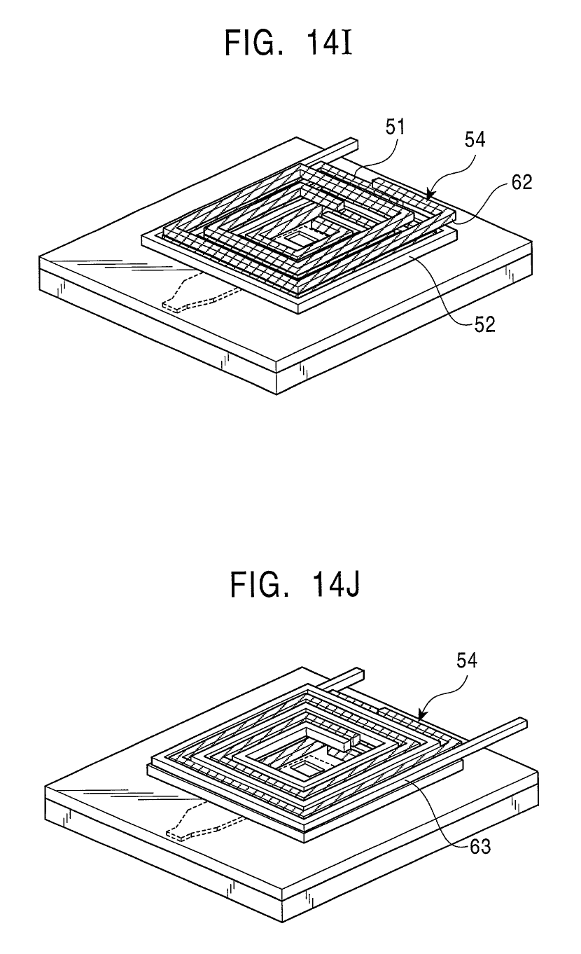

Next, as shown in FIG. 14I, an insulating film 62 comprising, for example, an alumina film is formed to cover the conductor 61 of the first coil 54 of the upper coil layer 56. As a result, the first coil 54 of the upper coil layer 56 is formed.

Then, as shown in FIG. 14J, the conductor 63 of the second coil 55 of the upper coil layer 56 is formed. In this step, the conductor 63 is formed so that the internal end fills in the connection hole to be electrically connected to the conductor 58 of the first coil 51 of the lower coil layer 53 through the connection hole.

As a result, the four coils 51, 52, 54 and 55 of the upper and lower coil layers 53 and 56 are connected in one line.

Then, an interlayer insulating film is formed to cover the thin film coil 57 comprising the lower and upper coil layers 53 and 56. In this step of forming the interlayer insulating film, the back gap hole 41 is masked to be avoided from being filled with the interlayer insulating film, or the interlayer insulating film on the back gap hole 41 is removed.

Furthermore, the upper magnetic core layer 34 is formed above the thin film coil 57 and the lower magnetic core layer 33 so as to fill in the back gap hole 41. Therefore, the upper magnetic core layer 34 is connected to the lower magnetic core layer 33 through the back gap hole 41 to form a magnetic path.

In this way, the inductive thin film magnetic head 50 shown in FIG. 10 can be produced.

Like in the thin film magnetic head 30 of the previous embodiment, in the thin film magnetic head 50 of this embodiment, the gaps between the conductors 58 and 60, and 61 and 63 of the thin film coil can be decreased, and the thickness of the thin film coil can be increased to decrease the resistance. Therefore, the efficiency of electromagnetic transformation can be improved, and the sizes of the magnetic cores 33 and 34 can be decreased to miniaturize the whole size of the magnetic head 50.

In the thin film magnetic head 50 of this embodiment, particularly, the thin film coil 57 has a two-layer structure comprising the lower coil layer 53 and the upper coil layer 56, thereby causing the advantage that the number of turns of the coil can be increased with a short magnetic path and a small area, and the overwrite property of the magnetic head 50 can be improved.

The inductive thin film magnetic head may have another construction comprising a plurality of coil layers which are electrically separated from each other, and each of which comprises two coils.

The inductive thin film magnetic head 30 or 50 of the above embodiment can be used as such a helical scanning magnetic head 200 as shown in FIG. 15, for example.

As shown in FIG. 15, the magnetic head 200 for magnetic recording on a magnetic tap 201 is provided on a cylindrical drum member 204 comprising upper and lower drums 203 and 202 so that the magnetic tape 201 travels along the drum member 204 to perform magnetic recording by the magnetic head 200.

In the inductive thin film magnetic head 30 or 50 of the above embodiment, the coil resistance is decreased to improve the efficiency of electromagnetic transformation, thereby improving the frequency responsiveness of such a helical scanning magnetic head 200.

A further embodiment of the present invention will be described below.

In this embodiment, the thin film coil is applied to a thin film inductor.

The thin film coil applied to the thin film inductor is different from the thin film coil for a magnetic head in that one end of the thin film coil is connected to the outside, while the other end is a free end.

FIG. 16 shows an embodiment in which the thin film coil is applied to a planar thin film inductor.

The thin film inductor 70 shown in FIG. 16 comprises a thin film coil comprising a first coil 72 and a second coil 73 which are formed on a substrate 71.

The external end 72A of the first coil 72 is connected to a conductor 76 on the substrate 71 at the left end shown in FIG. 16, and the internal end 72B of the first coil 72 is connected to the external end 73A of the second coil 73 through wiring 74, the internal end 73B of the second coil 73 being a free end.

Also, a conductor 75 is formed on the substrate 71 at the right end opposite to the conductor 76. The conductor 75 is not connected to the thin film coil.

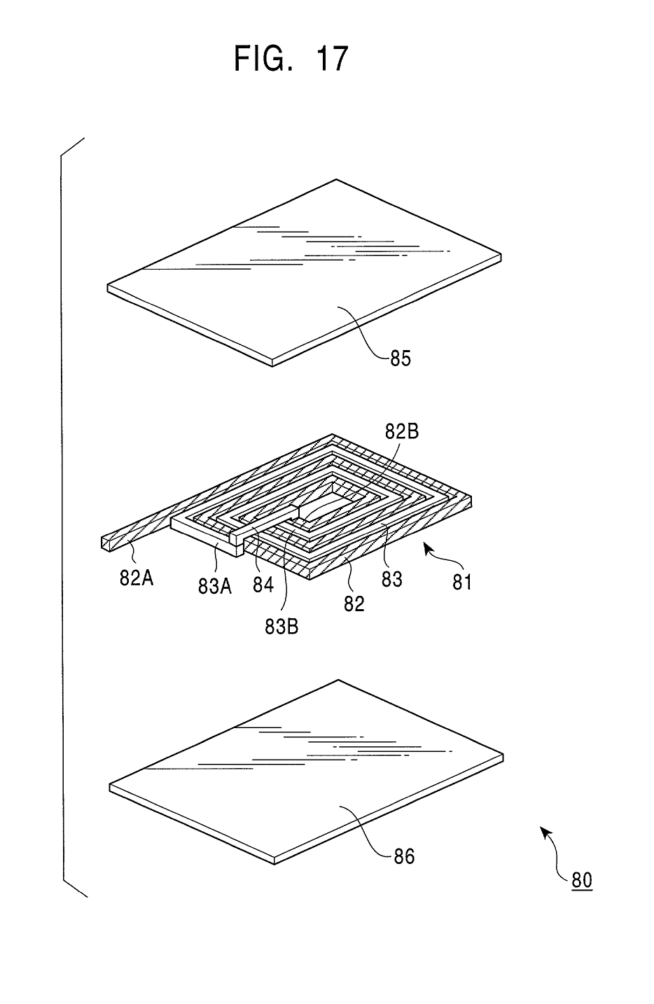

FIG. 17 shows an embodiment in which the thin film coil is applied to a laminated planar thin film inductor.

FIG. 17 is an exploded view showing the laminated structure of the thin film inductor.

The thin film inductor 80 shown in FIG. 17 comprises a thin film coil 81 comprising a first coil 82 and a second coil 83.

The external end 82A of the first coil 82 is extended to be connected to the outside, and the internal end 82B of the first coil 82 is connected to the external end 83A of the second coil 83 through wiring 84, the internal end 83B of the second coil 83 being a free end.

Furthermore, magnetic films 85 and 86 are provided above and below the thin film coil 81 through insulating films (not shown in the drawing).

Since the thin film inductor 70 or 80 comprises the thin film coil having the construction of the present invention, the coil pitch can be decreased, and the thickness of the coil can be increased to decrease the coil resistance.

By increasing the aspect ratio of the coil or decreasing the coil width to 5 μm or less, the resistance can be prevented from increasing due to a skin effect in the radio frequency region to maintain a low resistance.

Also, the thin film inductor 70 or 80 can be miniaturized by increasing the number of turns of the coil per unit area, or decreasing the area of the thin film coil.

Such a thin film inductor can be used as, for example, a micro inductor for a cellular phone.

A further embodiment of the present invention will be described below.

In this embodiment, the thin film coil of the present invention is applied to a thin film magnetic sensor.

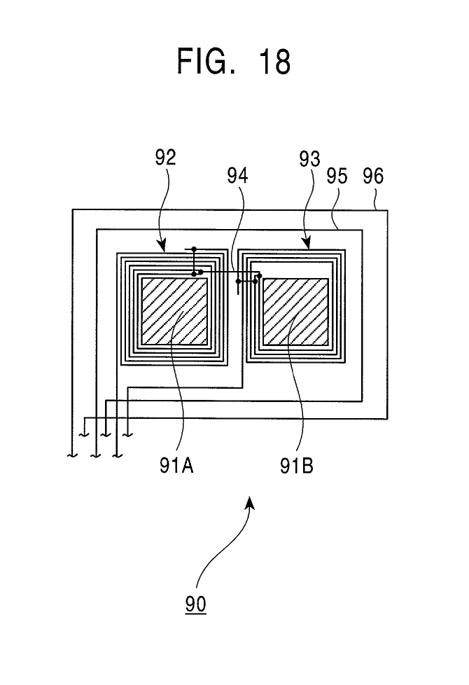

FIG. 18 shows the embodiment in which the thin film coil is applied to a thin film magnetic sensor.

The thin film magnetic sensor 90 shown in FIG. 18 comprises high-permeability material films 91A and 91B formed as magnetic cores at two positions on a substrate not shown in the drawing, and thin film coils 92 and 93 provided around the high-permeability material films 91A and 91B, respectively. Each of the thin film coils 92 and 93 has the same construction as the thin film coil of the present invention, in which two coils are connected to each other, and ends of the two coils are connected through wiring 94. Also, both coils have opposite wiring directions.

Furthermore, a receiving coil 95 and a feedback coil 96 each comprising a thin film are formed outside the thin film coils 92 and 93.

The thin film coils 92 and 93 function as exciting coils which can produce AC magnetic fluxes in opposite directions in the high-permeability material films 91A and 91B when a current with a specified period is passed from the outside. The induced voltage produced in the receiving coil 95 due to the magnetic fluxes is converted into a DC voltage signal (proportional to an external measured magnetic field) by an external circuit, and further amplified to be output as a magnetic field measuring signal. A current is fed back to the feedback coil 96 through a negative feedback circuit (not shown) so as to cancel the DC magnetic fluxes produced by the measured magnetic field in the high-permeability material films 91A and 91B, permitting high-precision measurement of a magnetic field based on a zero method.

Namely, the thin film magnetic sensor 90 is a flux gate-type magnetic sensor comprising a thin film (refer to, for example, Japanese Unexamined Patent Application Publication No. 8-201061).

Such a thin film magnetic sensor can be used as a magnetic sensor for correcting earth magnetism, and a magnetic sensor for detecting a weak magnetic field.

The thin film magnetic sensor 90 comprises the thin film coil having the construction of the present invention, and thus the coil resistance can be decreased.

Therefore, the quantity of the current of the coil can be increased with the same applied voltage, and the applied voltage necessary for magnetically saturating the high-permeability material films 91A and 91B serving as the magnetic cores can be decreased.

Also, the thin film magnetic sensor 90 can be miniaturized by increasing the number of turns of the coil per unit area, or decreasing the area of the thin film coil.

The thin film coil, the thin film magnetic head, the thin film inductor and the thin film magnetic sensor of the above embodiments are typical examples, and various modifications can be made for the constructions of detailed portions,

For example, in the thin film coil, the winding direction, the number of turns of the coil, the method of connecting wiring can be changed arbitrarily.

Besides the thin film coil, the above-described method of forming a thin film coil of the present invention can be applied to formation of a metal thin film by plating or the like.

For example, in forming wiring in any one of various circuit devices by using a metal thin film, the wiring interval can be decreased.

The present invention is not limited to the above-described embodiments, and various constructions may be used in the range of the gist of the present invention.

The above-described thin film coil and the method of forming the same of the present invention permit the conductors of first and second coils of the thin film coil to be securely insulated by an insulating film.

Therefore, the coil pitch can be decreased to, for example, 1.5 μm or less, as compared with conventional coils.

Also, even when the coil thickness is increased, the conductors can be insulated, and thus the thickness of the coil can be increased to, for example, 4 μm or more, as compared with conventional coils.

Therefore, the aspect ratio (coil height/coil width) of the coil can easily be increased to, for example, 3 or more, and the thickness of the coil can be increased to decrease the coil resistance and inductance.

Furthermore, the conductors can be securely insulated by an insulating film, thereby improving the yield of coil formation.

In a thin film magnetic head, a thin film inductor, and a thin film magnetic sensor each comprising the thin film magnetic coil of the present invention, the thin film coil can be formed with a narrow interval and low resistance, and thus the thin film magnetic head, the thin film inductor, and the thin film magnetic sensor can be improved in properties (for example, electromagnetic transformation), and miniaturized.

What is claimed is:

1. A thin film coil comprising at least a first coil and a second coil formed on a same substrate and each comprising a conductor thin film;
wherein at least the entire side surfaces of the conductor of the first coil are covered with an insulating film; and
the conductor of the second coil is formed on the substrate with the insulating film formed therebetween.

2. A thin film coil according to claim 1, wherein the conductor of the first coil is formed on the substrate with a plating underlying film provided therebetween, and the conductor of the second coil is formed on the insulating film with a plating underlying film provided therebetween.

3. A method of forming a thin film coil comprising:
the step of forming a plating underlying film on a substrate;
the step of depositing a conductor of a thin film coil in a predetermined pattern by plating on the plating underlying film;
the step of etching off the plating underlying film except the portion below the conductor to form a first coil of the thin film coil;
the step of forming an insulating film over the entire surface;
the step of forming a second plating underlying film on the insulating film;
the step of forming a conductor of a second coil of the thin film coil in a predetermined pattern by plating on the portion of the second plating underlying film, which corresponds to the pitch interval of the first coil; and
the step of removing the second plating underlying film on the insulating film of the first coil.

4. A thin film magnetic head comprising a thin film coil comprising at least a first coil and a second coil formed on a same substrate, two magnetic cores provided with the thin film coil held therebetween, and a magnetic gap held between the tip portions of the two magnetic cores;
wherein at least the entire side surfaces of the conductor of the first coil are covered with an insulating film; and
the conductor of the second coil is formed on the substrate with the insulating film formed therebetween.

5. A thin film inductor comprising a thin film coil comprising at least a first coil and a second coil formed on a same substrate;
wherein at least the entire side surfaces of the conductor of the first coil are covered with an insulating film;
the conductor of the second coil is formed on the substrate with the insulating film formed therebetween;
the first coil and the second coil of the thin film coil are electrically connected to each other; and
one end of the thin film coil is connected to the outside, the other end being a free end.

6. A thin film magnetic sensor comprising a thin film coil comprising at least a first coil and a second coil formed on a same substrate;
wherein at least the entire side surfaces of the conductor of the first coil are covered with an insulating film; and
the conductor of the second coil is formed on the substrate with the insulating film formed therebetween.
